(19) United States
(12) Patent Application Publication
(10) Pub. No.: US 2026/0263950 A1
(43) Pub. Date: Sep. 10, 2026

(54) Immersive Punching Arcade System

(71) Applicant: Golden Net IT Structure LLC, Dubai (AE)

(72) Inventor: Eesa Abdul Aziz Salmin, Dubai (AE)

(21) Appl. No.: 19/556,562

(22) Filed: Mar. 4, 2026

Related U.S. Application Data
(60) Provisional application No. 63/767,011, filed on Mar. 5, 2025.

(51) Int. Cl. A63F 13/833; A63F 13/211; A63F 13/213; A63F 13/46; A63F 13/73; A63F 13/798

(52) U.S. Cl. CPC A63F 13/833; A63F 13/211; A63F 13/213; A63F 13/46; A63F 13/73; A63F 13/798

(57) ABSTRACT

A punching arcade system is disclosed, comprising a housing unit, a support assembly, a movable punching bag suspended from a mounting structure of the support assembly, and a retraction mechanism configured to selectively move the punching bag between a playing position and a retracted position. The system further includes a rotating shaft operatively coupled to the mounting structure and configured to rotate in response to movement of the punching bag, and a spring assembly configured to compress proportionally to an impact force applied by a player. At least one sensor assembly is provided and configured to detect movement and/or impact of the punching bag and to generate corresponding sensing signals. A game control system is configured to process the sensing signals to calculate punch-related metrics, including speed, impact force, pressure per square inch (PSI), kinetic energy, and momentum, and to display corresponding performance data on an interactive display screen.

### CROSS-REFERENCE TO RELATED APPLICATION

This application claims the benefit of an earlier filing date from U.S. Provisional Application Ser. No. 63/767,011 filed on Mar. 5, 2025, which is hereby incorporated herein by reference in their entirety.

### FIELD OF THE INVENTION

The present disclosure generally relates to immersive arcade gaming systems, and more particularly to a punching arcade system that integrates a physical punching apparatus with a built-in display screen, high-speed motion capture technology, slow-motion video replay functionality, real-time performance analysis and feedback mechanisms, and seamless connectivity with a mobile application and web-based platform. The disclosed system is configured to provide users with an interactive, data-driven experience by combining physical engagement with advanced digital features for performance tracking, instant feedback, comparative analytics, and personalized performance assessment.

### BACKGROUND OF THE INVENTION

Traditional punching arcade machines typically include a punching bag suspended from a frame or support structure, configured to receive a single strike or successive strikes in in one direction (generally in a linear direction). Upon impact, the punching bag contacts a sensor assembly, usually positioned at an upper portion in a cabinet, to measure the force of the punch. In some designs, the punching bag automatically returns to its resting position after impact, while in others it remains in an elevated position and must be manually released, such as by pressing a reset button, before subsequent use.

A common issue of conventional or existing punching arcade machines is the construction and size of the punching bag. Many existing machines utilize relatively small bags with rigid internal components. Improper striking technique, excessive force, or rapid repeated punching may cause the player's hand or arm to contact the hardened internal structure, potentially resulting in discomfort or injury. Additionally, accurate measurement of punch force and speed depends heavily on the alignment and calibration of the associated sensors. Over time, misalignment or component displacement can degrade measurement accuracy, adversely affecting game reliability, player's performance and the player satisfaction.

Conventional systems are also susceptible to mechanical wear and tear, particularly in components such as the punching bag, return mechanism, locking assembly, and impact sensors. These components are subject to significant stress during frequent use, which can lead to mechanical failure, reduced durability, and increased maintenance requirements. Mechanical or contact-based sensors, in particular, may deteriorate under heavy usage, resulting in inconsistent or unreliable performance data.

Security and payment mechanisms in many conventional punching arcade machines are relatively basic. Coin-operated systems are common, and such configurations may be vulnerable to tampering, bypassing of payment systems, or unauthorized access, thereby reducing revenue and operational efficiency in commercial arcade environments and also particularly where revenue generation is essential for maintaining operations.

In addition, conventional punching arcade machines typically provide limited user engagement features. The measured punch force is often displayed as a simple numeric value, such as in pounds or kilograms, on a basic digital display. While such quantitative feedback informs the player of the measured force, it lacks immersive or motivational features. Some machines provide cumulative scores or local leaderboards; however, these features are generally static, confined to the individual machine, and do not offer personalized analysis, contextual performance insights, or enhanced visual feedback.

Existing arcade systems generally operate as standalone units with minimal integration with external platforms. Player interaction is typically restricted to physical inputs and locally stored scores, with little or no connectivity to mobile devices, cloud-based systems, or online networks. As a result, user profiles, historical performance data, remote competitions, and global leaderboards are not effectively supported.

Although modern technologies such as including mobile applications, cloud computing, and IoT (Internet of Things) offer potential opportunities to enhance interactivity, analytics, and monetization, most prior punching arcade machines do not incorporate such capabilities in an integrated manner. Consequently, they fail to provide real-time visual replay, player engagement, advanced motion analysis, remote participation features, real-time feedback, or global interaction.

Thus, there has existed a long-felt need for an advanced punching arcade platform that overcomes the foregoing limitations of the prior art. The present invention addresses this need by providing an integrated punching arcade system that combines a physical punching apparatus with advanced digital technologies, including high-speed motion capture, real-time data processing, slow-motion replay, interactive display interfaces, and seamless integration with mobile and web-based applications. The system enables user profile management, real-time performance feedback, secure digital payment options, cloud-based synchronization, and remote competitive participation. By integrating physical gameplay with advanced software and network connectivity, the invention enhances user engagement, improves measurement reliability, supports remote monitoring and data management, and promotes increased player retention and revenue generation.

### SUMMARY OF THE INVENTION

Aspects of the present invention provide an immersive punching arcade system that integrates a punching arcade machine with an interactive display screen, high-speed motion capture technology, slow-motion replay capability, real-time analysis and feedback mechanisms, and seamless integration with a mobile application and web-based platform.

One aspect of the present invention, a punching arcade system comprising a housing unit and a punching bag suspended within the housing unit by a support assembly including a mounting structure. A rotating shaft is operatively coupled to the mounting structure and is configured to rotate in response to movement of the punching bag. A spring is operatively coupled to the rotating shaft and is configured to compress proportionally to an impact force applied to the punching bag. The system further includes a retraction mechanism configured to selectively move the punching bag between a playing position and a retracted position. At least one sensor assembly is positioned to define a predetermined sensed zone and is configured to detect movement of the punching bag within the sensed zone. An interactive display screen is disposed on the housing unit, and a game control system is operatively connected to the sensor assembly, the display screen, and the retraction mechanism. When the punching bag is struck by a player, the punching bag swings along a predefined arc, causing rotation of the rotating shaft and corresponding compression of the spring. The sensor assembly detects interruption of a beam when the punching bag moves into the sensed zone and generates detection signals, which are received and processed by the game control system to calculate one or more punch-related metrics and to display corresponding performance data on the display screen.

In one aspect of the present invention, the punching arcade system includes a movable punching bag suspended from the support structure. The punching bag is coupled to a retraction mechanism configured to selectively lower the punching bag into a playing position for gameplay and retract the punching bag after completion of a session, thereby preventing unauthorized access and unintended movement when the system is not in use.

The punching arcade system includes the sensor assembly, which detects when the punching bag swings into a designated area and makes contact with the support structure. This detection triggers the scoring system, which increments the player's score within a set time limit, adding an element of challenge and competition to the experience.

In one aspect of the present invention, the punching arcade system further includes at least one camera configured to capture video or image data of a player during gameplay, wherein the game control system processes the captured data to generate slow-motion replays and performance analysis. The display screen is configured to present real-time punch metrics, cumulative scores, leaderboard rankings, and multimedia content including recorded gameplay footage. The system may also include a payment module configured to accept digital payments, card payments, and cash payments, and to transmit payment confirmation signals to the game control system to initiate gameplay. In addition, the punching arcade system is integrated with a mobile application and a cloud-based server, wherein the mobile application communicates with the game control system, punch metrics and score data are synchronized with the cloud-based server, and player profiles and leaderboard data are accessible across multiple arcade systems. The game control system is further configured to capture and process detailed performance data for each punch delivered by a user, including parameters such as punch speed, pressure per square inch (PSI), kinetic energy, impact force, momentum, and a highest score value achieved by the player on a particular arcade unit.

In another aspect, the system includes the one or more high-speed, high-definition, high-frame-rate cameras configured to capture a user's punching motion in detail, enabling slow-motion video replay and performance analysis. The cameras record the punching technique from initiation through impact, thereby facilitating technique evaluation and improvement.

In another aspect, the system employs real-time analysis and feedback mechanisms. Algorithms process motion capture data and sensor inputs to calculate punch-related metrics including punch strength, speed, accuracy, kinetic energy, and form. These metrics are displayed on the arcade display screen and transmitted to a companion mobile application.

In addition to the mobile application, the invention includes a web-based platform that permits secure user login, access to gameplay history, analytics dashboards, slow-motion video review, and account customization.

A back-end management portal supports the system and includes a device management dashboard configured for real-time monitoring of arcade unit status, connectivity, location tracking, deployment management, and content distribution across multiple arcade systems.

Accordingly, the present invention provides an integrated physical and digital arcade platform that combines mechanical gameplay, motion capture technology, analytics processing, mobile and web connectivity, and social engagement features to enhance user experience, competition, and skill development.

Overall, the present invention offers an immersive and engaging punching arcade experience by seamlessly integrating physical gameplay with advanced motion capture technology, real-time analysis and feedback mechanisms, and a comprehensive mobile and web-based platform. This integration fosters user engagement, community building, skill development, and a heightened sense of competition and motivation among punching arcade enthusiasts.

The improved design provides a more immersive and engaging boxing game particularly suited for arcade and public entertainment environments. The integration of advanced sensing, motion capture, real-time analytics, multimedia feedback, and digital connectivity enhances the depth and complexity of gameplay while maintaining ease of use. The structural configuration and controlled retraction mechanism contribute to reduced mechanical wear and lower maintenance requirements. Additionally, the incorporation of digital payment systems, cloud connectivity, and user engagement features increases player interaction, repeat participation, and overall revenue generation potential for arcade operators.

The summary of the invention is not intended to limit the key features and essential technical features of the claimed invention, and is not intended to limit the scope of protection of the claimed embodiments.

### BRIEF DESCRIPTION OF THE DRAWINGS:

The accompanying drawings are included to provide a further understanding of the present invention and are incorporated in and constitute a part of this specification. The drawings illustrate exemplary embodiments of the present invention and, together with the description, serve to explain the principles of the present disclosure.

FIG. 1 illustrates a punching arcade system, in accordance with an embodiment of the present invention;

FIG. 2 illustrates a support assembly for suspending the punching bag in the punching arcade system, in accordance with an embodiment of the present invention;

FIG. 3 illustrates the punching bag in a retracted position with the support assembly, in accordance with an embodiment of the present invention;

FIG. 4 illustrates a front view of the punching arcade system; and

FIG. 5 shows a block diagram of a control system in accordance with an embodiment of the present invention

### DETAILED DESCRIPTION OF THE INVENTION

While the present invention is described herein by way of example using embodiments and illustrative drawing, those skilled in the art will recognize that the invention is not limited to the embodiments of drawing, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalent, and alternatives falling within the scope of the present invention as defined by the appended claims.

As used throughout this description, the word “may” is used in a permissive sense (i.e. meaning having the potential to), rather that the mandatory sense, (i.e. meaning must). Further, the words “a” or “an” mean “at least one” and the word “plurality” means “one or more” unless otherwise mentioned. Furthermore, the terminology used herein is solely used for descriptive purposes and should not be construed as limiting in scope. Language such as “including”, “comprising”, “having”, “containing”, or “involving” and variations thereof, is intended to be broad and encompass the subject matter listed thereafter. Any discussion of documents, acts, materials, devices, articles is for providing a context for the present invention. It is not suggested or represented that any or all of these matters form part of the prior art base or were common general knowledge in the field relevant to the present invention.

The present invention is described hereinafter by various embodiments with reference to the accompanying drawings, wherein reference numerals used in the accompanying drawings correspond to the like elements throughout the description. This invention may, however, be embodied in many different forms and should not be construed as limited to the embodiment set forth herein. Rather, the embodiment is provided so that the disclosure will be thorough and complete and will fully convey the scope of the invention to those skilled in the art. In the following detailed description, numeric values and ranges may be provided for various aspects of the implementation described. These ranges and values are to be treated as examples only, and are not intended to limit the scope of the claims. In addition, a number of materials may be identified as suitable for various facets of the implementations. These materials are to be treated as exemplary, and are not intended to limit the scope of the invention.

Embodiments of the present invention provides a punching arcade system for advanced boxing arcade game configured for installation and operation in arcades and other public environments, such as restaurants, shopping malls, fitness centers, and entertainment venues. The system is adapted to capture and process detailed performance data for each punch delivered by a user, including parameters such as punch speed, pressure per square inch (PSI), kinetic energy, impact force, momentum, and highest score values achieved by a player on a particular arcade unit.

The system further enables players to view and compare their scores with those of other users, thereby promoting competitive engagement and motivating performance improvement. By facilitating score comparison, performance tracking, and interactive feedback, the invention enhances player interaction and provides a more immersive and engaging gaming experience.

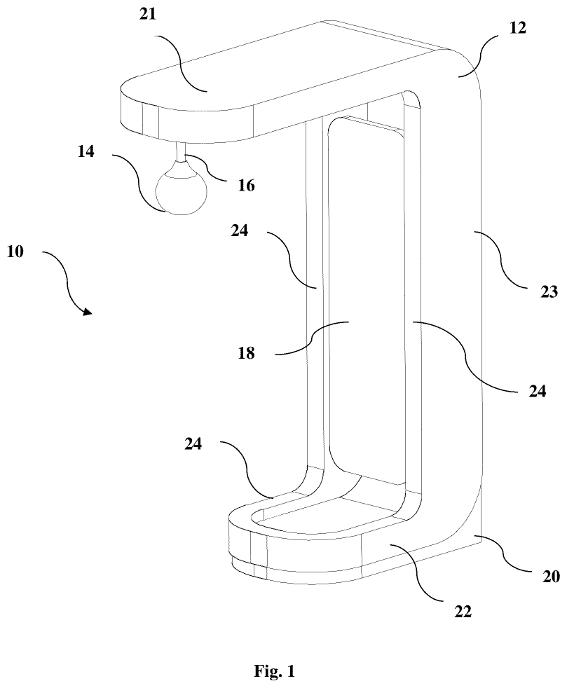

Embodiments of the present invention are described herein with reference to the accompanying figures. In one embodiment, as illustrated in FIG. 1, a punching arcade system or punching arcade apparatus or punching arcade machine 10 comprises a housing unit 12, a punching object such as a punching bag 14, a support structure 16 from which the punching bag 14 is suspended, an interactive display screen 18, and an anchoring base plate 20 disposed at a lower portion of the housing unit 12 for stabilizing and supporting the system 10 on a ground surface.

The housing unit 12 includes a front top extended panel 21, a front bottom extended panel 22, and a main body portion 23 configured to enclose and protect internal components of the punching arcade system 10, including the interactive display screen 18 and associated electronic modules.

The housing unit 12 further include illumination elements 24, such as an LED tube lights, configured to provide enhanced visual effects during gameplay. The illumination elements 24 may be programmed to indicate gameplay status, highlight high scores, signify achievements, or provide other visual cues. In alternative embodiments, a plurality of illumination elements 24, including LED strips, bulbs, or programmable light modules, may be incorporated without limiting from the scope of the invention.

The punching bag 14 is configured to be struck by a player during gameplay. In one embodiment, the punching bag 14 is inflatable and is filled with air or another suitable medium to provide a resilient and pliable striking surface. The inflatable configuration allows the punching bag 14 to absorb impact forces, enhance user safety, and improve durability during repeated use.

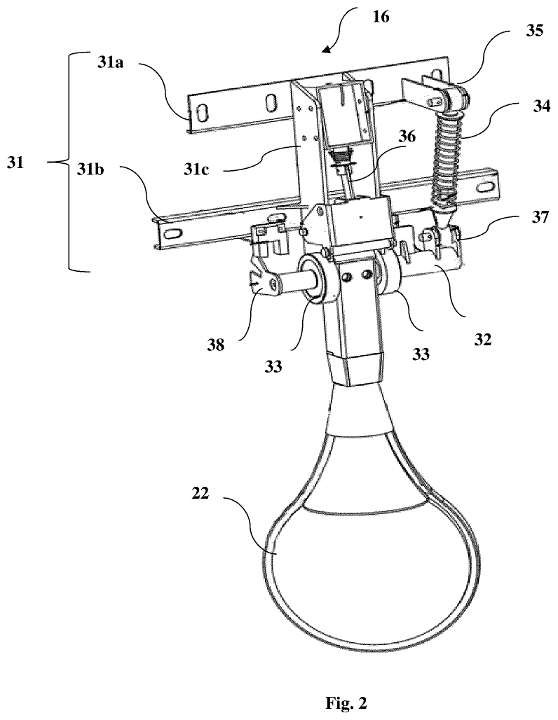

FIG. 2 illustrates the support structure 16, which includes a concealed frame 31. The concealed frame 31 comprises an upper horizontal frame member 31a, a lower horizontal frame member 31b, and a middle vertical frame member 31c extending between the upper horizontal frame member 31a and the lower horizontal frame member 31b. A mounting structure 36, configured to facilitate elevation and retraction of the punching bag 14, is housed within the middle vertical frame member 31c.

A rotating shaft 32 is attached horizontally to the mounting structure 36 by means of a pair of bearing systems 33, which enable smooth rotational movement and allow the punching bag 14 to swing within a predetermined path or zone. The concealed frame 31 provides structural support for a rotating shaft 32, from which the punching bag 14 is suspended, ultimately supporting for suspending the punching bag 14.

The support structure 16 further includes a spring 34 mounted in a generally vertical orientation, and connected to the upper horizontal frame member 31a by one end via a first attachment member 35, and further the spring 34 is operatively connected to the rotating shaft 32 by another end via a second attachment member 37 and is configured to support elevation and retraction movement of the punching bag 14. The lower horizontal frame member 31b is also operatively coupled to the rotating shaft 32, forming part of the retraction mechanism and contributing to controlled return of the punching bag 14 to its resting position after impact.

Upon application of an impact force to the punching bag 14, the rotating shaft 32 is displaced, thereby actuating the spring 34 and causing the spring 34 to compress in proportion to the magnitude of the applied force. Greater impact forces result in correspondingly greater compression of the spring 34. During this displacement, the punching bag 14 moves from a resting position toward an impact position, at which point it engages or contacts the lower horizontal frame member 31b. Such movement enables detection and measurement of the applied force and facilitates controlled retraction of the punching bag 14 back to its resting position under the restoring bias of the spring 34.

In one embodiment, the punching bag 14 is inflatable and encased within a leather or similar durable outer covering to withstand repeated impacts. The punching bag 14 is coupled to the rotating shaft 32 such that, when struck by a player, the punching bag 14 swings in a controlled, substantially unidirectional path.

Punch-related metrics, including speed and other kinematic parameters, are measured during each strike delivered to the punching bag 14. Sensors are configured to detect movement of the punching bag 14 as it passes through a predefined sensing zone. The sensor determines parameters such as elapsed time, velocity, and impact force, and a processing unit computes corresponding performance data to generate accurate measurement results. In one embodiment, interruption of a sensing beam by the punching bag 14 is used as a trigger event for calculating impact-related values and updating the player's game score.

The system 10 further includes a height-adjustment mechanism (not shown in figure) configured to selectively raise or lower the punching bag 14 within a predefined vertical range, thereby accommodating players of different heights and ensuring comfortable and ergonomic gameplay.

Additionally, the system 10 includes a retaining mechanism configured to hold the punching bag 14 in a secured, elevated position such as adjacent to an upper interior portion of the housing when the game is not in progress. This prevents unintended swinging or unauthorized use of the punching bag 14. The punching bag 14 is automatically released upon initiation of a valid game session, such as when a player selects a multi-attempt mode or scans a QR code to authenticate and begin play.

The system 10 and associated method allow a player to deliver a single strike or multiple strikes to the punching bag 14, depending on the selected gameplay mode, thereby providing flexible play options tailored to user preference.

Further, as illustrated in FIG. 2, an induction plate 38 is operatively coupled to the rotating shaft 32 and is configured to be detected by at least one sensor during movement of the punching bag 14. Detection of the induction plate 38 as it passes through a sensing region enables precise tracking of displacement and velocity of the rotating shaft 32. Based on the measured parameters, the system 10 calculates performance metrics and correspondingly updates the player's score in accordance with the magnitude and quality of the strike.

In one embodiment, an emitter-detector sensor is employed to reliably track movement of the punching bag 14. The non-contact sensing configuration enhances measurement accuracy and is designed to resist mechanical degradation over extended periods of use.

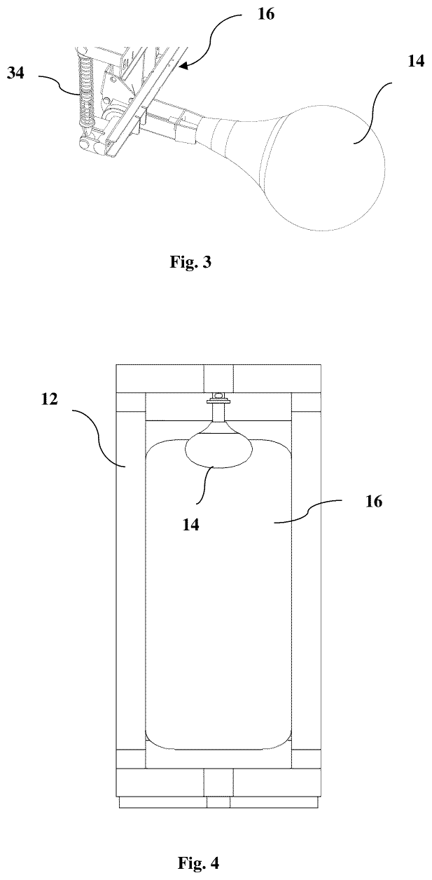

Additionally, as illustrated in FIG. 3, the system 10 includes a retraction mechanism configured to elevate or withdraw the punching bag 14 when the game is inactive. This feature prevents unauthorized strikes by passersby who have not initiated a valid gameplay session, thereby making the system 10 particularly suitable for arcade game or other minimally supervised environments and improving revenue protection and overall commercial value.

FIG. 4 illustrates a front view of the housing unit 12, including a display section presented on the display screen 18. According to one embodiment of the present invention, the system 10 includes an integrated feedback system configured to present dynamic visual content to the player. The feedback system may display real-time visuals, including live video capture, slow-motion replay, still images, and performance-related graphics, enabling the player to observe and analyse their striking technique and overall performance directly on the display screen 18. Such real-time and replay-based visual feedback enhances user engagement and facilitates performance assessment and improvement.

The housing unit 12 provides structural support for the punching arcade system 10 and encloses the various mechanical, electrical, electronic and software components described herein. In one embodiment, the housing unit 12 is made from a reinforced metal frame construction configured to withstand repeated impact forces and continuous public use.

The housing unit 12 incorporates the display screen 18, which in one embodiment is a high-resolution digital 4K display. The display screen 18 is configured to present multiple categories of player-related information, including, but not limited to, data from the most recently played game session, the player's last recorded score, the highest score achieved by the current player, comparative score data relative to other players, and leaderboard rankings.

The display screen 18 may further display a machine-readable code, such as a QR code, enabling first-time users to scan and download a dedicated mobile application, referred to in one embodiment as a Punching App. The QR code may also facilitate user authentication, profile access, digital wallet loading, or arcade operator account integration prior to commencement of gameplay.

Additionally, the display screen 18 may be configured to present promotional or advertising content, including content associated with fitness, sports equipment, health-related products, or other commercial partners. The display screen 18 is further adapted to present real-time and replay-based multimedia content, including slow-motion video recordings and high-resolution images captured during a punch event, thereby enhancing player engagement and overall user experience.

In another embodiment, the housing unit 12 incorporates a plurality of cameras. At least one high-definition camera is positioned in front of the punching bag 14 to capture frontal views of the player during impact events. An additional camera may be positioned adjacent to, or on a side of, the display screen 18 such as on the right side to capture a wider field of view of the gameplay area. The camera arrangement is configured to record still images and video footage of the player's movements, striking technique, and, where applicable, spectator reactions, thereby enabling enhanced visual feedback and replay functionality

The display screen 18 further includes an interactive interface configured to facilitate payment and user authentication. In one embodiment, the interface enables scanning of a QR code for digital payment, loading of credits, or downloading of a dedicated mobile application to a user's mobile device. The system 10 may also include a cash insertion module configured to accept physical currency for initiating or authorizing gameplay. The punching arcade system 10 is equipped with a cash acceptor capable of receiving currency notes in multiple denominations.

The cash acceptor may include a note stacker mechanism configured to organize and stack accepted notes for convenient removal by an operator or supervisor. This configuration improves cash handling efficiency compared to systems that utilize only a collection box, which may result in disorganized currency and increased processing time.

The housing unit 12 may further include dual speakers positioned on opposing sides of the arcade cabinet, optionally incorporating bass output to provide immersive audio effects. The audio system is programmable to generate distinct sound effects corresponding to various operational states, including standby mode, player registration, credit loading, game initiation, achievement of high scores, and other gameplay events. Additionally, the illumination elements 24 or a plurality of LED tube lights may be incorporated to generate dynamic lighting effects during gameplay, highlight achievements, and visually indicate system status.

The display screen 18 is further secured by impact-resistant safety glass, such as glass rated to IK10 standards. An IK10 rating corresponds to resistance against impact energy of up to approximately 20 joules, equivalent to the force generated by a 5 kg mass dropped from a height of approximately 400 mm. The IK10-rated protective layer enhances durability and vandal resistance of the display screen 18, providing robust protection against unintended impacts, including accidental strikes, and reducing the likelihood of breakage during operation in public environments.

The system 10 is further equipped with multiple network connectivity options, including Wi-Fi, wired LAN, and a 4G SIM-based cellular communication module. These connectivity features enable the arcade system to remain online for real-time data synchronization, remote monitoring, software updates, cloud-based score management, and integration with external platforms.

In one embodiment, the system 10 includes a set of removable wheels positioned at a rear portion of the housing unit 12, such as two upper wheels and two lower wheels, to facilitate relocation of the unit when required. Additionally, removable anchor bolts are provided to assist in lifting or repositioning the arcade system 10, particularly in view of its substantial weight.

Additionally, a maintenance shaft is provided at an upper portion of the punching arcade system 10 to allow convenient access to the punching and suspension mechanisms for servicing or inspection. Further, a rear access door is incorporated into the housing unit 12 to provide maintenance access to internal components, including electronic modules, power systems, and payment devices.

Unlike conventional boxing arcade machines that rely primarily on a heavy base structure to maintain stability during impact, the system 10 is mounted on an anchoring base plate 20. The base plate 20 is configured to be securely fastened to a floor surface using anchor bolts and includes a groove or locking mechanism configured to receive and secure the lower portion of the arcade system 10. The arcade unit is slidably engaged with the base plate 20 and locked in position, ensuring that both the front and rear lower portions of the system 10 are firmly secured to the ground. This configuration minimizes wobbling or displacement during high-force impacts to the punching bag 14.

In contrast to traditional designs featuring a substantially 90-degree rear bottom edge resting directly on the floor to improve weight distribution, the present system incorporates a curved lower rear profile for enhanced aesthetics, while maintaining structural stability through the integrated locking mechanism and anchored base plate configuration.

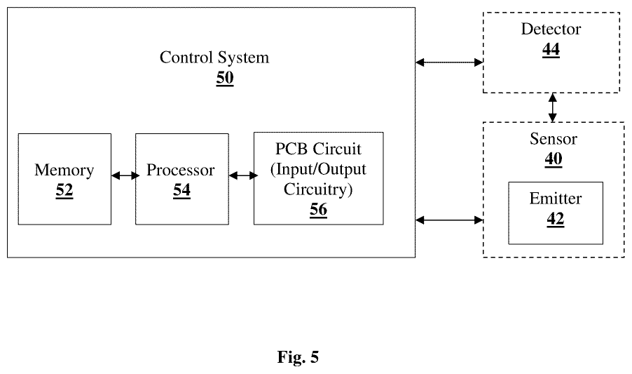

As illustrated in FIG. 5, a control system or a controller 50, the control system 50 includes a processor 54, computer readable memory 52 and a PCB circuit board (input/output circuitry) 56. The processor 54, the computer readable memory 52 and the input/output circuitry 56 may communicate with each other via one or more suitable data communication buses. In one embodiment, the sensor 40 includes an emitter 42 configured to emit a beam of electromagnetic energy and a detector 44 configured to receive the emitted beam. When movement of the punching bag 14 or an associated component interrupts the beam, the detector senses the interruption and transmits corresponding signals to a game control system 50 for processing, and data analysis. The sensor 40 determines parameters such as elapsed time, velocity, and impact force, and a processing unit computes corresponding performance data to generate accurate measurement results.

In conventional punching arcade machines presently available in the market, score outputs are typically limited to three-digit numerical values, thereby restricting score resolution and differentiation among players. In contrast in another embodiment, the present system incorporates controller-level enhancements, enabling higher-resolution data acquisition from speed sensors and load sensors. Specifically, the controller is configured to process sensor signals with increased numerical precision and expanded digit capacity relative to traditional systems. As a result, raw impact parameters, including punch speed and applied load, are captured with significantly greater accuracy and over an expanded measurable range. When processed using an appropriate scoring algorithm, these high-resolution measurements are scalable to generate scores within a nine-digit numerical range. This expanded score distribution enables substantially improved differentiation of player performance across large user populations and significantly reduces, or effectively eliminates, the occurrence of duplicate score values among different players.

In one embodiment of the present invention, a method of operating the arcade game is provided. A player positions himself or herself in front of the punching arcade system 10 and delivers a punch to the punching bag 14, causing the punching bag 14 to swing along a defined arc, generally toward a forward direction. When the punching bag 14 is struck towards the front, it reaches an impact position at which it interrupts a beam emitted by the emitter. The detector registers each interruption of the beam and transmits corresponding signals to the game control system. The punching bag 14 is thereby driven into a predefined sensed zone located toward the front of the system 10, where the emitted beam is positioned for accurate detection and scoring.

A retraction mechanism is provided to selectively move the punching bag 14 between a playing position and a retracted position. When the arcade game is inactive, the punching bag 14 remains in the retracted position, preventing unintended swinging or unauthorized use by passersby.

In the retracted configuration, the punching bag 14 is elevated into an upper portion of the arcade system 10, with only a portion of the bag visible from the exterior. In this locked state, the punching bag 14 is restrained from free movement, thereby placing the arcade system 10 in a standby mode. During standby mode, the display screen 18 may present advertisements, promotional content, or recorded videos of previous players.

Upon initiation of a valid game session, such as by insertion of payment or digital authorization, the game control system actuates the retraction mechanism to lower the punching bag 14 into the playing position. The punching bag 14 is then free to swing upon impact. The bearing system 33 permits-controlled pendulum-like movement of the punching bag 14 along a designated path (from point A to point B), such as between a first position (point A) and a second position (point B), thereby restricting motion to intended directions and enhancing measurement accuracy.

The display screen 18 includes a game score display configured to track and present the player's performance during gameplay. The system updates and displays the game score in real time based on detected punch metrics. The display screen 18 may further present high scores, rankings, and comparative performance data for current and previous players.

In certain embodiments, a progressive bonus scoring feature may be implemented, whereby additional points are awarded when predefined performance milestones are achieved. As a non-monetary incentive, the system may also grant additional punch attempts or extended play time when a player reaches predetermined goals during the game session, thereby enhancing engagement and competitive motivation.

Upon completion of a game session, the retraction mechanism actuates to return the punching bag 14 to the retracted position and securely holds it in place, thereby preventing movement while the game is inactive. The punching bag 14 is released from the retracted position only upon initiation of a subsequent valid gameplay event, such as when the same player selects a multiple-punch option or when a new player properly initiates a game session.

The retracted configuration is further designed to resist forced displacement, such that attempts to manually pull or strike the punching bag 14 while in the retracted position do not result in unintended release. This arrangement prevents unauthorized use of the punching bag 14 and enhances the security and revenue protection of the arcade system 10.

In another embodiment, the punching arcade system 10 comprises an integrated combination of hardware and software components configured to provide an immersive and interactive user experience. The system 10 includes a printed circuit board (PCB) disposed within the housing 12 and a game control system operatively connected to the sensors, cameras, display screen 18, payment modules, and retraction mechanism.

The punching arcade system 10 further integrates a dedicated punching application (Punching App), which in one embodiment is implemented on an Android-based software platform, along with a corresponding mobile application and cloud-based service infrastructure. These software components are configured to support real-time punch data acquisition, leaderboard updates, digital payment processing, user authentication, and profile management.

Players may interact with the arcade system 10 using their personal mobile devices or through an integrated tablet interface provided on or in association with the display screen 18. The software system collects, processes, and displays punch-related metrics, including force, speed, kinetic energy, momentum, and accuracy, based on signals received from the sensor assembly.

The Punching App is designed to support scalability and interoperability, enabling multiple arcade systems deployed at different geographic locations to connect to centralized cloud services for synchronized data management and global leaderboard functionality. The hardware components of the arcade system 10, including the sensors, imaging devices, PCB, and display screen 18, are communicatively linked with the game control system and associated software modules to ensure accurate, low-latency data transmission and coordinated system operation.

Through the Punching App, players are provided access to their performance metrics, including historical punch data, cumulative scores, rankings, and achievement records. The application enables real-time comparison of scores with other players across connected arcade systems and supports sharing of achievements, images, or gameplay highlights through social media platforms, thereby enhancing user engagement and competitive interaction.

In another embodiment of the present invention, an integrated operational framework of the punching arcade system 10 is provided, wherein coordinated interaction between hardware components and software modules enables execution of gameplay and associated services. The application of the integrated system may be described through the following operational steps:

### A. Initialization of the Punching Arcade System

Upon powering on the punching arcade system 10, the system 10 automatically performs a diagnostic routine to verify proper operation of hardware components, including the display screen 18, punch sensors, cameras, lighting modules, payment systems, and associated electronic circuits. Simultaneously, the system 10 establishes a network connection with a remote cloud server through available connectivity options, such as Wi-Fi, wired LAN, or a 4G SIM-based cellular network. This connection enables real-time data synchronization between the system 10 and the Punching App executed on a user's mobile device, thereby ensuring updated player profiles, gameplay history, rankings, and leaderboard data.

Following initialization, the display screen 18 presents a machine-readable code, such as a QR code, inviting players to scan the code to begin interaction with the system 10. When a new player scans the QR code, the player is redirected to a web-based interface where required details may be entered, gameplay options (such as number of punches) may be selected, payment may be processed, and the session may be initiated. The web interface provides a streamlined registration and onboarding process for first-time users.

For returning or existing players, scanning the QR code redirects them to the Punching App, where the player may log in, select gameplay options, complete payment, and initiate a session. This differentiation between new and existing users enhances usability and reduces transaction time, enabling rapid engagement with the arcade system 10.

An integrated interactive interface, such as a 10-inch tablet (TAB), is also provided as an alternative user interaction mechanism. The interactive interface enables players to scan QR codes, complete digital payment transactions, select gameplay parameters, and initiate the game directly through the arcade interface. This alternative access method provides redundancy and accommodates users who may not possess a compatible mobile device or who prefer direct interaction with the system 10.

### B. User Profile Creation and Management

The Punching App enables players to create and manage personalized user profiles. Upon registration, a new player is prompted to enter essential details, such as name, age, and gender. The entered information is transmitted to and securely stored in a cloud-based database operatively associated with the punching arcade system 10.

Once the profile is created, players can access their accounts across any compatible punching arcade system 10 using their registered credentials. Each user profile is associated with a unique cloud-based identifier, which allows synchronization of gameplay data, including historical performance metrics, high scores, rankings, and session history. As a result, player progress remains accessible irrespective of the physical arcade unit used.

The Punching App further enables users to review detailed gameplay statistics and compare their performance with that of other players through integrated leaderboard functionality. This comparative feature promotes competitive engagement and encourages recurring interaction with the punching arcade system 10 to improve individual rankings and performance outcomes.

### C. Payment Processing and Credit System

The punching arcade system 10 incorporates an integrated payment processing framework accessible through both the Punching App and the interactive interface. The system supports multiple payment methods, including credit cards, debit cards, online banking transfers, digital wallets (such as Google Pay or similar platforms), and physical cash payments via the onboard cash acceptor. Players may purchase punch sessions directly through the mobile application or via the interface provided on the arcade system 10.

Each registered player account within the Punching App is associated with a virtual wallet configured to store purchased credits. The stored credits may be redeemed for gameplay sessions on any compatible punching arcade system 10. The credit management system is synchronized in real time with a cloud server to ensure that the player's available balance is accurately reflected across multiple locations and devices. The system 10 may further support advance credit purchases, bundled session packages, or promotional credit offers to enhance user engagement and encourage repeat gameplay.

The punching application ensures secure payment processing through encryption and secure channels for data transmission between the player's mobile device, the arcade system 10, and the backend server. Once payment is made, a confirmation is sent to the arcade system 10, enabling the game to start.

### D. Game Initialization and Player Interaction

Once credits are loaded, the player can initiate the game either through the mobile application or by interacting with the interface. When the game begins, the arcade system 10 transitions from standby mode to active gameplay mode, with all associated hardware components cameras, sensors, lighting, and display activating simultaneously.

The mobile application interfaces with the punching arcade system 10 to track player progress in real time. Sensors embedded in the housing 12 hardware detect each punch's speed, force, and angle. This data is transmitted to the mobile app for immediate feedback. The real-time processing capabilities of the software allow players to see a graphical representation of their punch force, accuracy, and overall performance, and on the Arcade screen as well.

The system 10 also logs this data to the cloud server, allowing players to access their performance history after the game. This historical data enables players to track their improvement over time, fostering repeat play.

### E. Data Processing and Display

The punching arcade software processes and analyses the data collected from each punch in real time. Algorithms calculate metrics such as kinetic energy, punch force per square inch, and punch accuracy, offering players a comprehensive view of their performance.

The data is communicated to the display screen 10, which visually showcases punch statistics, high scores, and leaderboard standings. The data is also relayed to the player's mobile device, providing a more detailed analysis, including punch-by-punch breakdowns and comparative scores against other players.

Additionally, the software manages the synchronization of leaderboards across different arcade systems 10 in real-time. As soon as a player finishes their game, their score is automatically uploaded to the cloud, and all connected arcade systems 10 display the updated leaderboard.

### F. Real-time Leaderboard

A core feature of the punching arcade software is the real-time leaderboard, which encourages competition among players. The leaderboard is updated instantly as players complete their game sessions, comparing their scores with others in the same arcade or across multiple connected machines.

The leaderboard system is synchronized in real-time with the cloud, allowing players to track their position relative to others and boosting engagement with the arcade system 10. The leaderboard serves as a display of current rankings based on performance, fostering indirect competition as players strive to improve their scores.

### G. Multimedia and Social Media Integration

The punching arcade system 10 includes multimedia capabilities. The cameras embedded in the housing 12 of the arcade system 10 capture high-definition footage of players during gameplay, which is processed by the software to create slow-motion replays and action shots.

These replays are shown on the display screen 18 during idle moments in the game, creating an exciting and visually stimulating experience. Players can access this footage through the mobile application, where they have options to download or share it on social media platforms such as Instagram, Facebook, and Twitter.

This social media integration promotes both the player's achievements and the arcade system 10 itself. By sharing scores and gameplay videos, players can engage with a broader audience, attracting new users and increasing arcade participation.

### H. Software Architecture and Back-End System

The backend system supporting the punching arcade software is built on a cloud-based architecture designed to handle high volumes of data. The backend system processes data collected from individual arcade system 10, managing user profiles, score tracking, payment processing, and data synchronization.

The software employs a client-server model where the arcade system 10 and mobile application acts as clients, while the backend cloud server handles all data processing. This architecture ensures scalability, supports multiple connected system 10 and provide real-time data updates for all players.

The back-end system further includes a content management system (CMS) that allows administrators to manage and deploy multimedia content, such as images, videos, banners, and promotional materials, to individual arcade devices. The content management system (CMS) enables content customization based on factors like location, time of day, or special events, ensuring relevance and enhancing user engagement.

### I. Software and Hardware Integration

The integration between software and hardware in the Punching Arcade system 10 is seamless and crucial to the system's overall functionality. The software is designed to control and synchronize the hardware components such as the punch sensors, cameras, display screen, and payment interface ensuring they work together cohesively to provide an optimal player experience.

For example, when a punch is detected by the sensor, the software immediately processes the data, calculating key metrics such as speed, force, and accuracy. This data is then transmitted in real-time to update both the display screen 18 and the player's mobile application, ensuring immediate feedback for the player. Additionally, the cameras are integrated with the software to capture footage of the player at specific intervals during gameplay. The software ensures that the most impactful moments—such as successful punches or dynamic actions—are recorded, allowing them to be replayed and shared.

The integration of software and hardware extends to the payment system. When a player loads credits through the mobile app or the TAB interface, the software communicates with the arcade's hardware to update the system and authorize the game to begin. This communication ensures that the game is started without any delay, providing a smooth and enjoyable user experience.

This tight integration of software and hardware enables a highly responsive and dynamic arcade system, where every action taken by the player is immediately reflected both on the arcade system 10 and within the mobile app. The end result is a seamless, interactive, and engaging experience that encourages repeat play and enhances the social and competitive aspects of the game.

The implementations of the described technology, in which the system 10 is connected with a network server and a computer system capable of executing a computer program to execute the functions. The described technology is optionally implemented in software devices loaded in memory, stored in a database, and/or communicated via a wired or wireless network link, thereby transforming the computer system into a special purpose machine for implementing the described operations.

The embodiments of the invention described herein are implemented as logical steps in one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

What is claimed is:

1. A punching arcade system, comprising:
a housing unit;
a punching bag;
a support assembly including a mounting structure configured to suspend the punching bag within the housing unit;
a rotating shaft operatively coupled to the mounting structure and configured to rotate in response to movement of the punching bag;
a spring operatively coupled to the rotating shaft and configured to compress proportionally to an impact force applied to the punching bag;
a retraction mechanism configured to selectively move the punching bag between a playing position and a retracted position;
at least one sensor assembly positioned to define a predetermined sensed zone and configured to detect movement of the punching bag within the sensed zone;
an interactive display screen disposed on the housing unit; and
a game control system operatively connected to the at least one sensor assembly, the display screen, and the retraction mechanism;
wherein:
the punching bag is configured to swing along a predefined arc when struck by a player, thereby causing rotation of the rotating shaft and compression of the spring;
the at least one sensor assembly is configured to detect interruption of a beam when the punching bag moves into the sensed zone and to generate corresponding detection signals; and
the game control system is configured to receive the detection signals, process the detection signals to calculate one or more punch-related metrics, and display corresponding performance data on the display screen.

2. The punching arcade system of claim 1, wherein the support structure includes a concealed frame positioned within the housing unit, the concealed frame comprising an upper horizontal frame member, a lower horizontal frame member, and a middle vertical frame member extending between the upper horizontal frame member and the lower horizontal frame member.

3. The punching arcade system of claim 1, wherein the spring mounted in a generally vertical orientation, a first end of the spring being connected to the upper horizontal frame member via a first attachment member, and a second end of the spring being operatively connected to the rotating shaft via a second attachment member, the spring being configured to facilitate elevation and retraction movement of the punching bag.

4. The punching arcade system of claim 1, wherein the mounting structure configured to suspend the punching bag, and also facilitate elevation and retraction of the punching bag, the mounting structure is placed on or within the middle vertical frame member.

5. The punching arcade system of claim 1, wherein the mounting structure configured to facilitate elevation and retraction of the punching bag is housed within the middle vertical frame member.

6. The punching arcade system of claim 1, wherein the rotating shaft is mounted at a lower end of the mounting structure by a pair of bearing systems configured to enable smooth rotational movement of the rotating shaft.

7. The punching arcade system of claim 1, wherein upon a strike to the punching bag, the rotating shaft is displaced to actuate the spring such that the spring compresses in proportion to a magnitude of the applied force, and wherein the punching bag moves from a resting position toward an impact position in which the punching bag engages the lower horizontal frame member, thereby enabling detection and measurement of the applied force and facilitating controlled return of the punching bag to the resting position under a restoring bias of the spring.

8. The punching arcade system of claim 1, wherein the punching bag is inflatable and wherein the punching bag is coupled to the mounting structure such that, when struck by a player, the punching bag swings in a controlled, substantially unidirectional path.

9. The punching arcade system of claim 1, wherein the at least one sensor assembly comprises an emitter-detector sensor configured to emit a beam and detect interruption of the beam to reliably track movement of the punching bag within the predetermined sensed zone.

10. A punching arcade a system, comprising:
a housing unit;
a punching bag configured to be struck by a player and to move in response to an applied impact force;
a support assembly configured to suspend the punching bag within the housing and to permit controlled movement of the punching bag along a predefined path;
a rotating shaft operatively coupled to a mounting structure and configured to rotate in response to movement of the punching bag;
a retraction mechanism configured to selectively move the punching bag between a playing position and a retracted position;
at least one sensor assembly configured to detect movement and/or impact of the punching bag and to generate corresponding sensing signals;
an interactive display screen; and
a game control system operatively connected to the at least one sensor assembly, the display screen, and the retraction mechanism;
wherein:
the game control system is configured to receive the sensing signals, determine one or more punch-related parameters based on the sensing signals, and cause performance information corresponding to the punch-related parameters to be presented on the display screen.

11. The punching arcade system of claim 10, wherein the sensor assembly comprises an emitter configured to emit an electromagnetic beam and a detector configured to detect interruption of the beam by movement of the punching bag.

12. The punching arcade system of claim 10, wherein an induction plate is operatively coupled to the rotating shaft, and is configured to be detected by the at least one sensor assembly during movement of the punching bag, and further the induction plate enables precise tracking of displacement and velocity of the rotating shaft.

13. The punching arcade system of claim 10, wherein the retraction mechanism is configured to lock the punching bag in the retracted position when the system is in standby mode and to release the punching bag only upon authorization of a valid gameplay session.

14. The punching arcade system of claim 10, further comprising at least one camera configured to capture video or image data of a player during gameplay, wherein the game control system processes the captured data to generate slow-motion replay or performance analysis.

15. The punching arcade system of claim 10, wherein the display screen is configured to display real-time punch metrics, cumulative scores, leaderboard rankings, and multimedia content including recorded gameplay footage.

16. The punching arcade system of claim 10, further comprising a payment module configured to accept digital payments, card payments, or cash payments, and to transmit payment confirmation to the game control system to initiate gameplay.

17. The punching arcade system of claim 10, further comprising a mobile application and a cloud-based server, wherein the mobile application communicates with the game control system, punch metrics and score data are synchronized with the cloud-based server, and player profiles and leaderboard data are accessible across multiple arcade systems.

18. The punching arcade system of claim 10, wherein the game control system is configured to capture and process detailed performance data for each punch delivered by a user, including one or more parameters selected from punch speed, pressure per square inch (PSI), kinetic energy, impact force, momentum, and a highest score value achieved by the player on a particular arcade unit.
